(19) United States
(12) Patent Application Publication
(10) Pub. No.: US 2006/0046048 A1
(43) Pub. Date: Mar. 2, 2006

(54) Film layers made from polymer blends

(76) Inventors: Mridula Kapur, Lake Jackson, TX (US); Staci A. DeKunder, Pearland, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/541,832

(22) PCT Filed: Jan. 28, 2004
(86) PCT No.: PCT/US04/02329

§ 371 Date: Jul. 12, 2005

Related U.S. Application Data
(60) Provisional application No. 60/444,757, filed on Feb. 4, 2003.

(51) Int. Cl. B32B 27/32

(52) U.S. Cl. 428/349; 428/523; 428/910; 526/348.1

(57) ABSTRACT

Film layers made from formulated polymer compositions are disclosed. Film layers made from such formulated compositions have suprisingly good heat seal properties, and an especially good reduction in heat seal initiation temperature. The polymer compositions preferably have at least one homogeneously branched ethylene/alpha-olefin interpolymer and at least one heterogeneously branched ethylene polymer. The homogeneously branched ethylene/alpha-olefin interpolymer has a density lower than that of the formulated composition and of the heterogeneously branched ethylene polymer.

This invention relates to compositions comprising specific polymer blends. The polymer blends preferably comprise:
(A) at least one homogeneously branched ethylene/alpha-olefin interpolymer having specific characteristics, blended together with
(B) a heterogeneously branched ethylene polymer.

Such compositions are particularly useful in film applications (e.g., heat sealable packaging film).

For many years, the heat shrinkable films industry has endeavored to reduce film gauge while maintaining performance in response to initiatives associated with source reduction. Lower gauges allow for increased footage on rolls, which benefits the customer by reducing downtime (changeover time).

However, prior strategies involving films having single resin layers or conventional melt blends of resins, especially linear low density polyethylene (LLDPE), typically resulted in performance concessions. For instance, some improvement in optical quality and percent free shrink, may have been seen, but with an undesirable degradation in impact strength. In the case of other blend compositions, good impact resistance and abrasion resistance could be obtained, but with an accompanying degradation in free shrink and clarity.

Thus, the technical challenge remained to design display films with higher impact resistance than LLDPE but with optical and shrink properties comparable to LLDPE. The inventors have found that the use of a multicomponent polymer compositions permits property tailoring without compromising clarity, impact resistance, free shrink, or resistance to tear propagation. The result is a stronger, more abuse resistant film having the shrink and optical properties presently provided by LLDPE. These inventive films result in lower failures at a processor's packaging machine, or during distribution of contents. The tensile strength of this film is superior to many conventional films, thereby permitting downgauging. A down-gauged film with performance properties comparable to prior LLDPE formulations at their previous gauge can account for less downtime and changeovers at the customer's plant owing to the above mentioned greater roll footage. The ability to deliver higher value heat shrinkable film without a significant cost premium is a distinct advantage of the films of this invention. Other resins recognized for providing certain performance features (that is clarity, seal initiation temperature, low temperature shrink) such as metallocene resins, or other blends, cannot provide abrasion resistance, nor deliver low temperature and low haze performance without a substantial cost penalty.

The use of select polymer compositions thus provides superior mechanical strength properties while preserving excellent optical and shrink values comparable to for example D955™ film. These performance attributes can lead to higher performance films at comparable thickness relative to current LLDPE films or to thinner films.

An improved packaging film in accordance with the present invention can thus provide adequate resistance to tear propagation; excellent free shrink; good optics, including haze, clarity, and gloss values; high impact resistance; and high tensile strength.

Surprisingly, we have now discovered that film can have synergistically enhanced physical properties, especially when the film is made from a blend of at least one homogeneously branched ethylene/alpha-olefin interpolymer and a heterogeneously branched ethylene/alpha-olefin interpolymer.

### BRIEF DESCRIPTION OF THE DRAWINGS

FIG. 1 shows the CRYSTAF curve for a polymer composition suitable for use in the films of this invention (Example 1).

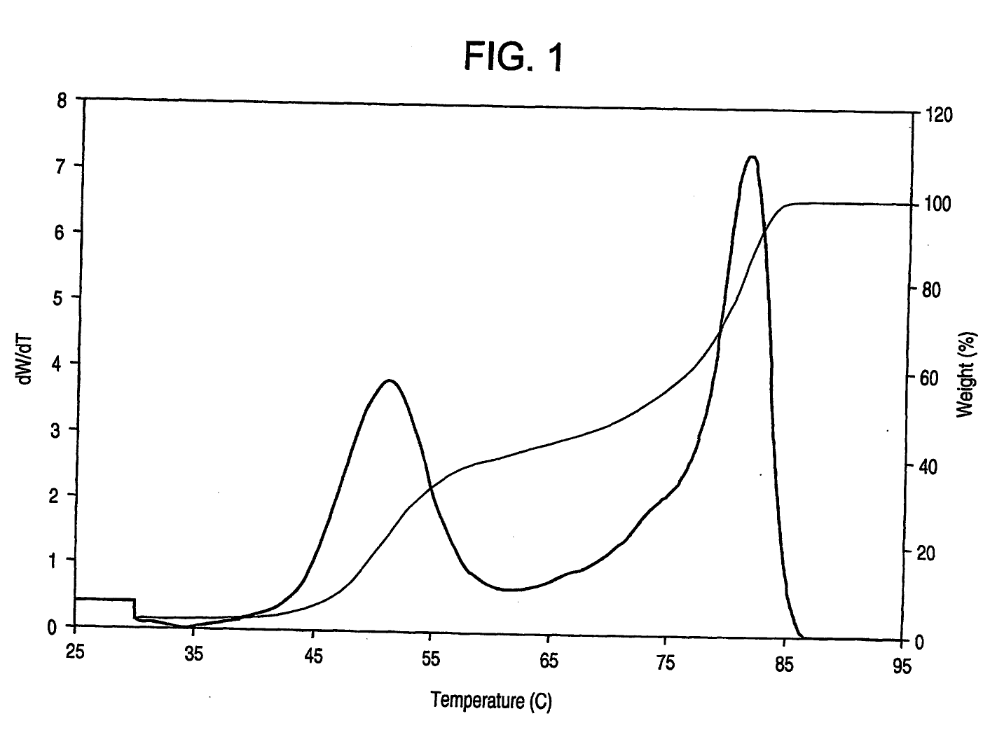

FIG. 2 shows the Heat Seal Strength versus sealing temperature for Example 1 and DOWLEX 2045G.

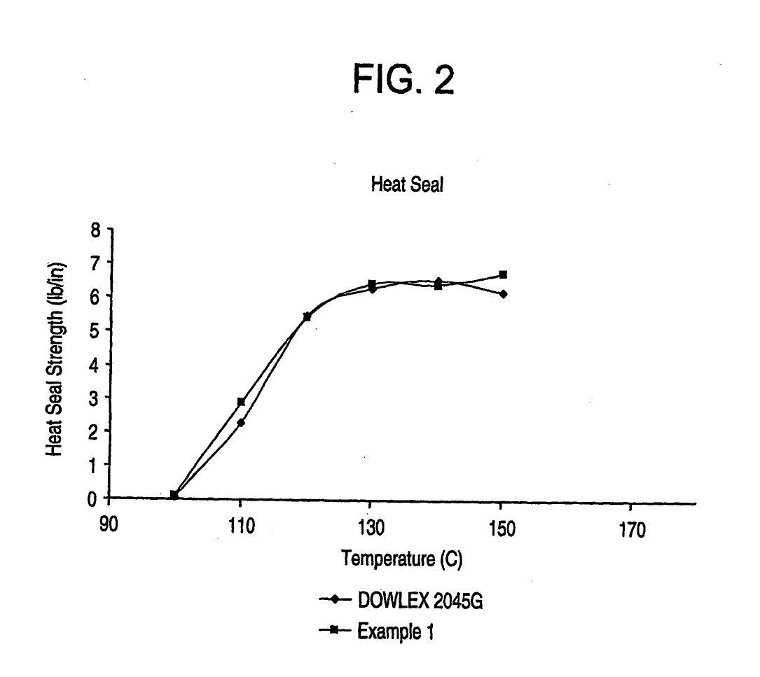

FIG. 3 shows the Hot Tack Strength versus temperature for Example 1 and DOWLEX 2045G.

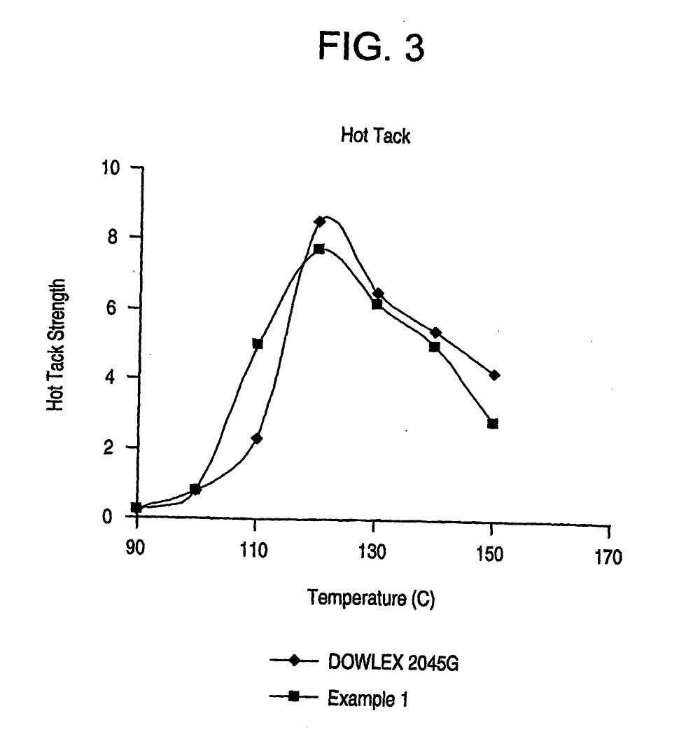

Formulated compositions have now been discovered to have improved physical and mechanical strength and are useful in making fabricated articles. Films and film layers made from these novel compositions exhibit surprisingly good heat seal properties at low heat seal initiation temperatures and are useful as sealants.

In one aspect, the invention is at least one film layer made from a polymer composition, wherein the composition has at least two peaks, as determined using a CRYSTAF scan, from a temperature range from 35° C. to 100° C., wherein the CRYSTAF scan has an absence of a peak at a temperature range from 60° C. to 70° C.

The compositions preferably comprise:

(A) from 10 percent (by weight of the total composition) to 95 percent (by weight of the total composition) of at least one homogeneously branched interpolymer having:
   (i) a density from 0.86 grams/cubic centimeter (g/cm³) to 0.92 g/cm³,
   (ii) a molecular weight distribution (Mw/Mn) from 1.8 to 2.8,
   (iii) a melt index (I₂) from 0.2 grams/10 minutes (g/10 min) to 200 g/10 min,
   (iv) no high density fraction; and
   (B) from 5 percent (by weight of the total composition) to 90 percent (by weight of the total composition) of at least one heterogeneously branched polymer having a density from 0.88 g/cm³ to 0.945 g/cm³,
      wherein the density of (A) is lower than the density of (B).

In another aspect, the invention is a multilayer oriented heat shrinkable film comprising:
a) outer layers comprising an ethylene polymer composition having a melt index of less than 5 g/10 minutes, the composition comprising
   i) a homogeneous component having a melt index of less than 2 g/10 minutes, and a density of at least 0.88 g/cc, and
   ii) a heterogeneous component with a melt index of greater than or equal to 2 g/10 minutes up to 20 grams/10 minutes and a density greater than that of the homogeneous component, and
      an internal layer comprising a polymeric resin; wherein the film has a heat seal initiation temperature of 110° C. or less to achieve a heat seal strength of at least 2 pounds peak load.

In a third aspect, the invention is a multilayer oriented heat shrinkable film comprising:
a) outer layers comprising an ethylene polymer composition having at least two peaks, as determined using a CRYSTAF scan, from a temperature range from 35° C. to 100° C., wherein the CRYSTAF scan has an absence of a peak at a temperature range from 60° C. to 70° C. and
b) an internal layer comprising a polymeric resin;
wherein the film has a heat seal initiation temperature of 110° C. or less to achieve a heat seal strength of at least 2 pounds peak load.

In yet another aspect, a solid state oriented heat shrinkable film comprises between 50 and 100 percent, by volume of the total film, of a multicomponent ethylene/alpha-olefin resin having a melt index from 0.5 to 30 g/10 minutes, the resin comprising a homogeneous component having a melt index of less than 3 g/10 minutes, and a density of at least 0.86 grams/cubic centimeter, and a heterogeneous component with a melt index of between 0.2 and 200 g/10 minutes; and between 0 and 50 percent, by volume of the total film, of a polymeric resin; wherein the film has a haze value (ASTM D 1003-95) less than or equal to 5, a peak load/mil value (ASTM D 3763-95a) of at least 155 newtons/mil, and a free shrink (ASTM D 2732-83) at a temperature of 200° F. (93° C.). of at least 8 percent in either or both of the longitudinal and transverse directions. The film is preferably a multilayer film. The polymeric resin is preferably different in composition from the multicomponent ethylene/alpha-olefin resin having a melt index less from 0.5 to 30 g/10 minutes. The film preferably has a substantially balanced free shrink. Preferably, at least 50 percent by volume of the total film volume comprises a multicomponent ethylene/alpha-olefin resin having a melt index preferably from 0.5 to 30 g/10 minutes. Preferably, the film comprises greater than 0 percent, more preferably greater than 0.1 percent, such as greater than 1 percent, greater than 5 percent, or greater than 10 percent by volume of the total film, of the polymeric resin; and less than 100 percent, more preferably less than 99.9 percent, such as less than 99 percent, less than 95 percent, or less than 90 percent, by volume of the total film, of the multicomponent ethylene/alpha-olefin resin having a melt index preferably from 0.5 to 30 g/10 minutes.

The polymeric resin can comprise ethylene/alpha-olefin copolymer, ethylene/vinyl acetate copolymer, ethylene/alkyl acrylate copolymer, ethylene/acrylic acid copolymer, ionomer, propylene polymer and copolymer, and butylene polymer and copolymer.

Definitions

“Acrylic” herein refers to acrylic or to methacrylic.

“Composite free shrink” herein refers to a value determined by summing the percent free shrink in the longitudinal direction with the percentage free shrink in the transverse direction.

“CRYSTAF” herein refers to an analytical technique which can be used to characterize the composition of a polymer by means of a fractionation scheme based on crystallization isolation. Samples were analyzed by Polymer Char (Valencia Parc Tecnologic, PO Box 176 E46980, Paterna, Spain). The technique generates results equivalent to that provided from TREF. (see Monrabal (1994) J. Applied Poly. Sci. 52, 491; Soares et al, SPE Polyolefins XI p 287-312).

“Ethylene/alpha-olefin copolymer” (EAO) herein refers to copolymers of ethylene with one or more comonomers selected from C3 to C10 alpha-olefins such as propene, butene-1, hexene-1, octene-1, etc. in which the molecules of the copolymers comprise long polymer chains with relatively few side chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXACT™ resins supplied by Exxon, or long chain branched (HEAO) AFFINITY™ resins supplied by The Dow Chemical Company, or ENGAGE™ resins supplied by DuPont Dow Elastomers.

“Free shrink balance” herein refers to the value, which defines the percent of difference between the free shrink of a film in the longitudinal direction and the free shrink of the same film in the transverse direction at 240° F., defined by the mathematical relationship:

$$[ \frac{\vert {FS}_{TD} - {FS}_{LD} \vert}{{FS}_{TD}} ]$$

where:
FS=free shrink
TD=transverse direction
LD=longitudinal direction
   Films of the present invention preferably exhibit a free shrink balance of less than or equal to 30 percent.

“Heat shrinkable” herein refers to a property of a material which, when heated to a temperature of 200° F. (93° C.), will exhibit a free shrink (ASTM D 2732-83) of at least 8 percent in the longitudinal direction, and/or at least 8 percent in the transverse direction. Heat shrinkable films of this invention are solid state oriented as contrasted to hot blown films which are melt state oriented.

“High density polyethylene” (HDPE) herein refers to a polyethylene having a density of between 0.94 and 0.965 grams per cubic centimeter.

“Intermediate” herein refers to a layer of a multi-layer film which is between an outer layer and an internal layer of the film.

“Internal layer” herein refers to a layer which is not an outer or surface layer, and is typically a central or core layer of a film.

“LD” herein refers to the longitudinal direction, that is the direction of the film parallel to the path. “TD” herein refers to the transverse direction, that is the direction of the film transverse to the path of extrusion.

“Linear low density polyethylene” (LLDPE) herein refers to polyethylene having a density between 0.917 and 0.925 grams per cubic centimeter.

“Linear medium density polyethylene” (LMDPE) herein refers to polyethylene having a density between 0.926 grams per cubic centimeter and 0.939 grams per cubic centimeter.

“Outer layer” herein refers to what is typically an outermost, usually surface layer or skin layer of a multilayer film, although additional layers, coatings, and/or films can be adhered to it.

“Polymer” herein refers to homopolymer, copolymer, terpolymer, etc. “Copolymer” herein includes copolymer, terpolymer, etc.

“Solid state orientation” herein refers to the orientation process carried out at a temperature higher than the highest Tg (glass transition temperature) of resins making up the majority of the structure and lower than the highest melting point, of at least some of the film resins, that is at a temperature at which at least some of the resins making up the structure are not in the molten state. Solid state orientation may be contrasted to “melt state orientation” that is including hot blown films, in which stretching takes place immediately upon emergence of the molten polymer film from the extrusion die.

“Solid state oriented” herein refers to films obtained by either coextrusion or extrusion coating of the resins of the different layers to obtain a primary thick sheet or tube (primary tape) that is quickly cooled to a solid state to stop or slow crystallization of the polymers, thereby providing a solid primary film sheet, and then reheating the solid primary film sheet to the so-called orientation temperature, and thereafter biaxially stretching the reheated film sheet at the orientation process (for example a trapped bubble method) or using a simultaneous or sequential tenter frame process, and finally rapidly cooling the stretched film to provide a heat shrinkable film. In the trapped bubble solid state orientation process the primary tape is stretched in the transverse direction (TD) by inflation with air pressure to produce a bubble, as well as in the longitudinal direction (LD) by the differential speed between the two sets of nip rolls that contain the bubble. In the tenter frame process the sheet or primary tape is stretched in the longitudinal direction by accelerating the sheet forward, while simultaneously or sequentially stretching in the transverse direction by guiding the heat softened sheet through a diverging geometry frame.

“Substantially balanced free shrink” herein refers to film of the invention characterized by a free shrink balance less than or equal to 30 percent.

All compositional percentages used herein are presented on a “by weight” basis, unless designated otherwise.

The homogeneously branched interpolymer is preferably a homogeneously branched substantially linear ethylene/alpha-olefin interpolymer as described in U.S. Pat. No. 5,272,236. The homogeneously branched ethylene/alpha-olefin interpolymer can also be a linear ethylene/alpha-olefin interpolymer as described in U.S. Pat. No. 3,645,992 (Elston).

The substantially linear ethylene/alpha-olefin interpolymers are not “linear” polymers in the traditional sense of the term, as used to describe linear low density polyethylene (for example, Ziegler polymerized linear low density polyethylene (LLDPE)), nor are they highly branched polymers, as used to describe low density polyethylene (LDPE). The substantially linear ethylene/alpha-olefin interpolymers used in the present invention are herein defined as in U.S. Pat. No. 5,272,236 and in U.S. Pat. No. 5,278,272.

The homogeneously branched ethylene/alpha-olefin interpolymers useful for forming the compositions described herein are those in which the comonomer is randomly distributed within a given interpolymer molecule and wherein substantially all of the interpolymer molecules have the same ethylene/comonomer ratio within that interpolymer. The homogeneity of the interpolymers is typically described by the SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the air, such as, for example, analytical temperature rising elution fractionation (abbreviated herein as “ATREF”) as described, for example, in Wild et al, Journal of Polymer Science, Poly. Phys. Ed., Vol. 20, p. 441 (1982), in U.S. Pat. No. 4,798,081 (Hazlitt et al.), or in U.S. Pat. No. 5,089,321 (Chum et al.). The SCBDI or CDBI for the linear and for the substantially linear olefin polymers of the present invention is preferably greater than 30 percent, especially greater than 50 percent. The homogeneous ethylene/alpha-olefin polymers used in this invention essentially lack a measurable “high density” fraction as measured by the TREF technique (that is, the homogeneously branched ethylene/alpha-olefin polymers do not contain a polymer fraction with a degree of branching less than or equal to 2 methyls/1000 carbons). The homogeneously branched ethylene/alpha-olefin polymers also do not contain any highly short chain branched fraction (that is, the homogeneously branched ethylene/alpha-olefin polymers do not contain a polymer fraction with a degree of branching equal to or more than 30 methyls/1000 carbons).

The substantially linear ethylene/alpha-olefin interpolymers for use in the present invention typically are interpolymers of ethylene with at least one C3-C20 alpha-olefin and/or C4-C18 diolefins. Copolymers of ethylene and 1-octene are especially preferred.

The term “interpolymer” is used herein to indicate a copolymer, or a terpolymer, or the like. That is, at least one other comonomer is polymerized with ethylene to make the interpolymer. Ethylene copolymerized with two or more comonomers can also be used to make the homogeneously branched substantially linear interpolymers useful in this invention. Preferred comonomers include the C3-C20 alpha-olefins, especially propene, isobutylene, 1-butene, 1-hexene, 4-methyl-1-pentene, 1-heptene, 1-octene, 1-nonene, and 1-decene, more preferably 1-butene, 1-hexene, 4-methyl-1-pentene and 1-octene.

The term “linear ethylene/alpha-olefin interpolymer” means that the interpolymer does not have long chain branching. That is, the linear ethylene/alpha-olefin interpolymer has an absence of long chain branching, as for example the linear low density polyethylene polymers or linear high density polyethylene polymers made using uniform (that is, homogeneous) branching distribution polymerization processes (for example, as described in U.S. Pat. No. 3,645,992 (Elston)) and are those in which the comonomer is randomly distributed within a given interpolymer molecule and wherein substantially all of the interpolymer molecules have the same ethylene/comonomer ratio within that interpolymer. The term “linear ethylene/alpha-olefin interpolymer” does not refer to high pressure branched (free-radical polymerized) polyethylene which is known to those skilled in the art to have numerous long chain branches. The branching distribution of the homogeneously branched linear ethylene/alpha-olefin interpolymers is the same or substantially the same as that described for the homogeneously branched substantially linear ethylene/alpha-olefin interpolymers, with the exception that the linear ethylene/alpha-olefin interpolymers do not have any long chain branching. The homogeneously branched linear ethylene/alpha-olefin interpolymers comprise ethylene with at least one C3-C20 alpha-olefin and/or C4-C18 diolefin. Copolymers of ethylene and 1-octene are especially preferred. Preferred comonomers include the C3-C20 alpha-olefins, especially propene, isobutylene, 1-butene, 1-hexene, 4-methyl-1-pentene, 1-heptene, 1-octene, 1-nonene, and 1-decene, more preferably 1-butene, 1-hexene, 4-methyl-1-pentene and 1-octene.

Both the homogeneously branched substantially linear and linear ethylene/alpha-olefin interpolymers can have a single melting point, as opposed to traditional heterogeneously branched Ziegler polymerized ethylene/alpha-olefin copolymers having two or more melting points, as determined using differential scanning calorimetry (DSC).

The density of the homogeneously branched ethylene/alpha-olefin interpolymers (as measured in accordance with ASTM D-792) for use in the present invention is generally from 0.86 g/cm³ to 0.92 g/cm³, preferably from 0.88 g/cm³ to 0.915 g/cm³, and especially from 0.89 g/cm³ to less than 0.91 g/cm³.

The amount of the homogeneously branched linear or substantially linear ethylene/alpha-olefin polymer incorporated into the composition varies depending upon the heterogeneously branched ethylene polymer to which it is combined.

The molecular weight of the homogeneously branched ethylene/alpha-olefin interpolymers for use in the present invention is conveniently indicated using a melt index measurement according to ASTM D-1238, Condition 190° C./2.16 kg (formerly known as “Condition (E)” and also known as I₂). Melt index is inversely proportional to the molecular weight of the polymer. Thus, the higher the molecular weight, the lower the melt index, although the relationship is not linear. The melt index limit for the homogeneously branched linear or substantially linear ethylene/alpha-olefin interpolymers is from 200 g/10 min, preferably 10 g/10 min, and can be as low as 0.2 g/10 min, preferably as low as 1 g/10 min.

Another measurement useful in characterizing the molecular weight of the homogeneously branched linear or substantially linear ethylene/alpha-olefin interpolymers is conveniently indicated using a melt index measurement according to ASTM D-1238, Condition 190° C./10 kg (formerly known as “Condition (N)” and also known as I₁₀). The ratio of the I₁₀ and I₂ melt index terms is the melt flow ratio and is designated as I₁₀/I₂. Generally, the I₁₀/I₂ ratio for the homogeneously branched linear ethylene/alpha-olefin interpolymers is 5.6. For the homogeneously branched substantially linear ethylene/alpha-olefin interpolymers used in the compositions of the invention, the I₁₀/I₂ ratio indicates the degree of long chain branching, that is, the higher the I₁₀/I₂ ratio, the more long chain branching in the interpolymer. Generally, the I₁₀/I₂ ratio of the homogeneously branched substantially linear ethylene/alpha-olefin interpolymers is at least 6, preferably at least 7, especially at least 8 or above. For the homogeneously branched substantially linear ethylene/alpha-olefin interpolymers, the higher the I₁₀/I₂ ratio, the better the processability.

Other additives such as antioxidants (for example, hindered phenolics (e.g., Irganox 1010 made by Ciba Geigy Corp.), phosphites (for example, Irgafos 168 also made by Ciba Geigy Corp.)), cling additives (for example, PIB), antiblock additives, pigments, fillers, can also be included in the formulations, to the extent that they do not interfere with the enhanced formulation properties discovered by Applicants.

Molecular Weight Distribution Determination

The molecular weight distributions of polyolefin, particularly ethylene, polymers are determined by gel permeation chromatography (GPC) on a Waters 150 C high temperature chromatographic unit equipped with a differential refractometer and three columns of mixed porosity. The columns are supplied by Polymer Laboratories and are commonly packed with pore sizes of 10³, 10⁴, 10⁵ and 10⁶ Å. The solvent is 1,2,4-trichlorobenzene, from which 0.3 percent by weight solutions of the samples are prepared for injection. The flow rate is 1.0 milliliters/minute, unit operating temperature is 140° C. and the injection size is 100 microliters.

The molecular weight determination with respect to the polymer backbone is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, p. 621, 1968:
M_{polyethylene}=a*(M_{polystyrene})^{b}.
In this equation, a=0.4316 and b=1.0. Weight average molecular weight, M_{w}, is calculated in the usual manner according to the following formula: Mⱼ=(Σwᵢ(Mᵢ^{j}))^{j}. Where wᵢ is the weight fraction of the molecules with molecular weight Mᵢ eluting from the GPC column in fraction i and j=1 when calculating M_{w} and j=−1 when calculating Mₙ.

For the homogeneously branched ethylene/alpha-olefin polymers, including both the linear and substantially linear ethylene/alpha-olefin polymers, the molecular weight distribution (Mw/Mn) is preferably from 1.8 to 2.8, more preferably from 1.89 to 2.2 and especially 2.

The Heterogeneously Branched Ethylene Polymer

The ethylene polymer to be combined with the homogeneous ethylene/alpha-olefin interpolymer is a heterogeneously branched (for example, Ziegler polymerized) interpolymer of ethylene with at least one C3-C20 alpha-olefin (for example, linear low density polyethylene (LLDPE)).

Heterogeneously branched ethylene/alpha-olefin interpolymers differ from the homogeneously branched ethylene/alpha-olefin interpolymers primarily in their branching distribution. For example, heterogeneously branched LLDPE polymers have a distribution of branching, including a highly branched portion (similar to a very low density polyethylene), a medium branched portion (similar to a medium branched polyethylene) and an essentially linear portion (similar to linear homopolymer polyethylene). Such manufacturing techniques for making the heterogeneously branched ethylene polymer is taught in U.S. Pat. No. 3,914,342 (Mitchell) and U.S. Pat. No. 4,076,698 (Anderson et al).

Examples of catalyst suitable for preparing the heterogeneous component are described in U.S. Pat. No. 4,314,912 (Lowery et al.), U.S. Pat. No. 4,547,475 (Glass et al.), and U.S. Pat. No. 4,612,300 (Coleman, III); examples of catalyst suitable for producing the homogeneous component are described in U.S. Pat. Nos. 5,026,798 and 5,055,438 (Canich); U.S. Pat. No. 3,645,992 (Elston); U.S. Pat. No. 5,017,714 (Welborn); and U.S. Pat. No. 4,076,698 (Anderson).

The amount of each of these fractions varies depending upon the whole polymer properties desired. For example, linear homopolymer polyethylene has neither branched nor highly branched fractions, but is linear. A very low density heterogeneous polyethylene having a density from 0.9 g/cm³ to 0.915 g/cm³ (such as ATTANE* copolymers, sold by The Dow Chemical Company and FLEXOMER* sold by Union Carbide Corporation) has a higher percentage of the highly short chain branched fraction, thus lowering the density of the whole polymer.

Heterogeneously branched LLDPE (such as DOWLEX sold by The Dow Chemical Company) has a lower amount of the highly branched fraction, but has a greater amount of the medium branched fraction.

More preferably, the heterogeneously branched ethylene polymer is a copolymer of ethylene with a C3-C20 alpha-olefin, wherein the copolymer has:
(i) a density from 0.88 g/cm³ to 0.945 g/cm³,
(ii) a melt index (I₂) from 0.01 g/10 min to 50 g/10 mm.

The Formulated Compositions

The compositions disclosed herein can be formed by any convenient method, including dry blending the individual components and subsequently melt mixing or by pre-melt mixing in a separate extruder (e.g., a Banbury mixer, a Haake mixer, a Brabender internal mixer, or a twin screw extruder).

U.S. Pat. No. 5,844,045, U.S. Pat. No. 5,869,575 and U.S. Pat. No. 6,448,341 describes, inter alia, interpolymerizations of ethylene and C3-C20 alpha-olefins using a homogeneous catalyst in at least one reactor and a heterogeneous catalyst in at least one other reactor. The reactors can be operated sequentially or in parallel.

The compositions can also be made by fractionating a heterogeneous ethylene/alpha-olefin polymer into specific polymer fractions with each fraction having a narrow composition (that is, branching) distribution, selecting the fraction having the specified properties, and blending the selected fraction in the appropriate amounts with another ethylene polymer. This method is obviously not as economical as the in-situ interpolymerizations of U.S. Pat. No. 5,844,045, U.S. Pat. No. 5,869,575 and U.S. Pat. No. 6,448,341, but can be used to obtain the compositions of the invention.

Fabricated Articles Made from the Novel Compositions

Many useful fabricated articles benefit from the novel compositions disclosed herein. For example, molding operations can be used to form useful fabricated articles or parts from the compositions disclosed herein, including various injection molding processes (for example, that described in Modern Plastics Encyclopedia/89, Mid October 1988 Issue, Volume 65, Number 11, pp. 264-268, “Introduction to Injection Molding” by H. Randall Parker and on pp. 270-271, “Injection Molding Thermoplastics” by Michael W. Green, and blow molding processes (for example, that described in Modern Plastics Encyclopedia/89, Mid October 1988 Issue, Volume 65, Number 11, pp. 217-218, “Extrusion-Blow Molding” by Christopher Irwin, profile extrusion, calandering, pultrusion (for example, pipes). Rotomolded articles can also benefit from the novel compositions described herein. Rotomolding techniques are well known to those skilled in the art and include, for example, those described in Modern Plastics Encyclopedia/89, Mid October 1988 Issue, Volume 65, Number 11, pp. 296-301, “Rotational Molding” by R. L. Fair.

Fibers (for example, staple fibers, melt blown fibers or spunbonded fibers (using, for example, systems as disclosed in U.S. Pat. Nos. 4,340,563, 4,663,220, 4,668,566, or 4,322,027, and gel spun fibers (for example, the system disclosed in U.S. Pat. No. 4,413,110), both woven and nonwoven fabrics (for example, spunlaced fabrics disclosed in U.S. Pat. No. 3,485,706, or structures made from such fibers (including, for example, blends of these fibers with other fibers, for example, PET or cotton)) can also be made from the novel compositions disclosed herein.

Film and film structures particularly benefit from the novel compositions described herein and can be made using conventional hot blown film fabrication techniques or other biaxial orientation processes such as tenter frames or double bubble processes. Conventional hot blown film processes are described, for example, in The Encyclopedia of Chemical Technology, Kirk-Othmer, Third Edition, John Wiley &amp; Sons, New York, 1981, Vol. 16, pp. 416-417 and Vol. 18, pp. 191-192. Biaxial orientation film manufacturing process such as described in a “double bubble” process as in U.S. Pat. No. 3,456,044 (Pahlke), and the processes described in U.S. Pat. No. 4,352,849 (Mueller), U.S. Pat. No. 4,597,920 (Golike), U.S. Pat. No. 4,820,557 (Warren), U.S. Pat. No. 4,837,084 (Warren), U.S. Pat. No. 4,865,902 (Golike et al.), U.S. Pat. No. 4,927,708 (Herran et al.), U.S. Pat. No. 4,952,451 (Mueller), U.S. Pat. No. 4,963,419 (Lustig et al.), and U.S. Pat. No. 5,059,481 (Lustig et al.), can also be used to make film structures from the novel compositions described herein. The film structures can also be made as described in a tenter-frame technique, such as that used for oriented polypropylene.

Other multi-layer film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 31-80 (published by TAPPI Press (1992)).

The films may be monolayer or multilayer films. The film made from the novel compositions can also be coextruded with the other layer(s) or the film can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, Jun. 15-17 (1981), pp. 211-229. If a monolayer film is produced via tubular film (that is, blown film techniques) or flat die (that is, cast film) as described by K. R. Osborn and W. A. Jenkins in “Plastic Films, Technology and Packaging Applications” (Technomic Publishing Co., Inc. (1992)), then the film must go through an additional post-extrusion step of adhesive or extrusion lamination to other packaging material layers to form a multilayer structure. If the film is a coextrusion of two or more layers (also described by Osborn and Jenkins), the film may still be laminated to additional layers of packaging materials, depending on the other physical requirements of the final film.

“Laminations Vs. Coextrusion” by D. Dumbleton (Converting Magazine (September 1992)), also discusses lamination versus coextrusion. Monolayer and coextruded films can also go through other post extrusion techniques, such as a biaxial orientation process.

Extrusion coating is yet another technique for producing multilayer film structures using the novel compositions described herein. The novel compositions comprise at least one layer of the film structure. Similar to cast film, extrusion coating is a flat die technique. A sealant can be extrusion coated onto a substrate either in the form of a monolayer or a coextruded extrudate.

The films and film layers of this invention are especially useful in vertical-form-fill-seal (VFFS) applications. Patents describing improvements for VFFS applications, especially polymer improvements, include U.S. Pat. No. 5,228,531; U.S. Pat. No. 5,360,648; U.S. Pat. No. 5,364,486; U.S. Pat. No. 5,721,025; U.S. Pat. No. 5,879,768; U.S. Pat. No. 5,942,579; U.S. Pat. No. 6,117,465.

Generally for a multilayer film structure, the novel compositions described herein comprise at least one layer of the total multilayer film structure. Other layers of the multilayer structure include but are not limited to barrier layers, and/or tie layers, and/or structural layers.

Various materials can be used for these layers, with some of them being used as more than one layer in the same film structure. Some of these materials include: foil, nylon, ethylene/vinyl alcohol (EVOH) copolymers, polyvinylidene chloride (PVDC), polyethylene terephthalate (PET), polypropylene, oriented polypropylene (OPP), ethylene/vinyl acetate (EVA) copolymers, ethylene/acrylic acid (EAA) copolymers, ethylene/methacrylic acid (EMAA) copolymers, LLDPE, HDPE, LDPE, nylon, graft adhesive polymers (for example, maleic anhydride grafted polyethylene), and paper. Generally, the multilayer film structures comprise from 2 to 7 layers.

Film can be made by cast extrusion (for monolayer films) or coextrusion (for multilayer films) by techniques well known in the art. The films can be quenched, irradiated by electron beam irradiation at a dosage of between 20 and 35 kiloGrays, and reheated to their orientation temperature, and then stretched at a ratio of 5:1 in each of the longitudinal and transverse directions.

Film of the present invention can be made by any suitable process, including coextrusion, lamination, extrusion coating, or corona bonding and are preferably made by tubular cast coextrusion, such as that shown in U.S. Pat. No. 4,551,380 (Schoenberg). Bags made from the film can be made by any suitable process, such as that shown in U.S. Pat. No. 3,741,253 (Brax et al.). Side or end sealed bags can be made from single wound or double wound films.

Film of the present invention can be oriented by any suitable process, including a trapped bubble process or a simultaneous or sequential tenterframe process.

Film of the present invention can have any total thickness desired, so long as the film provides the desired properties for the particular packaging operation in which the films is used. Final film thicknesses can vary, depending on process, end use application, etc. Typical thicknesses range from 0.1 to 20 mils, preferably 0.2 to 15 mils, more preferably 0.3 to 10 mils, more preferably 0.3 to 5 mils, more preferably 0.3 to 2 mils, such as 0.3 to 1 mil.

Film of the present invention can have a tear propagation (ASTM 1938) of between 3 and 10 grams in either or both of the longitudinal and transverse directions.

Film of the present invention can have a haze value of between 0.1 and 5, more preferably between 0.1 and 4.5, more preferably between 0.1 and 4, more preferably between 0.1 and 3.5, more preferably between 0.1 and 3.5, more preferably between 0.1 and 3, more preferably between 0.1 and 2.5, and most preferably between 0.1 and 2. Film of the invention can have a haze value of 5 or less than 5, 4 or less than 4, 3.5 or less than 3.5, 3 or less than 3, 2.5 or less than 2.5, 2 or less than 2, or 1 or less than 1.

The multilayer film of the present invention can have a peak load/ml value (ASTM D3763-95a) of at least 155, more preferably at least 160, more preferably at least 165, more preferably at least 167, more preferably at least 170, more preferably at least 170, more preferably at least 175, more preferably at least 180, more preferably at least 185, more preferably at least 190, and most preferably at least 195 newtons/mil. Preferred ranges for peak load/mil are between 155 and 400, more preferably between 155 and 390, more preferably between 160 and 380, more preferably between 165 and 370, more preferably between 167 and 360, more preferably between 170 and 350, more preferably between 175 and 340, more preferably between 180 and 330, more preferably between 185 and 320, more preferably between 190 and 310, and most preferably between 195 and 300 newtons/mil.

The polymeric components used to fabricate film according to the present invention can also contain appropriate amounts of other additives normally included in such compositions. These include slip agents, antioxidants, fillers, dyes, pigments, radiation stabilizers, antistatic agents, elastomers, and other additives known to those of skill in the art of packaging films.

The multilayer film of the present invention can have an energy to break/mil value (ASTM D3763-95a) of at least 1.28, more preferably at least 1.30, more preferably at least 1.35, more preferably at least 1.40, more preferably at least 1.45, more preferably at least 1.50, more preferably at least 1.55, more preferably at least 1.58, more preferably at least 1.60, more preferably at least 1.65, more preferably at least 1.70, more preferably at least 1.75, more preferably at least 1.80, more preferably at least 1.85, and most preferably at least 1.90 Joules/mil. Preferred ranges for energy to break per mil are between 1.28 and 4.00, preferably between 1.30 and 3.00, more preferably between 1.35 and 3.00, more preferably between 1.40 and 2.90, more preferably between 1.45 and 2.85, more preferably between 1.50 and 2.85, more preferably between 1.55 and 2.80, more preferably between 1.60 and 2.75, more preferably between 1.65 and 2.75, more preferably between 1.70 and 2.75, more preferably between 1.75 and 2.75, and most preferably between 1.80 and 2.50 Joules/mil.

The multilayer films of the present invention can exhibit a tensile strength (ASTM D 882-95) of preferably at least 18,000, more preferably at least 19,000, more preferably at least 20,000, more preferably at least 21,000, more preferably at least 21,500, more preferably at least 22,000, more preferably at least 22,500, and most preferably at least 23,000 psi in either or both of the longitudinal and transverse directions, and preferably in both the longitudinal and transverse directions. Preferred ranges for tensile strength are between 18,000 to 200,000, and more preferably between 23,000 and 100,000 psi in either or both of the longitudinal and transverse directions, and preferably in both the longitudinal and transverse directions.

The multilayer films of the present invention can exhibit a free shrink (ASTM D 2732-83) at a temperature of 200° F. (93° C.). of preferably at least 8 percent, more preferably at least 9 percent, more preferably at least 10 percent, more preferably at least 11 percent, more preferably at least 13 percent, and most preferably at least 15 percent in either or both of the longitudinal and transverse directions, and preferably in both the longitudinal and transverse directions. Preferred ranges for free shrink at a temperature of 200° F. (93° C.). are between 8 percent and 50 percent, more preferably between 10 percent and 45 percent, more preferably between 15 percent and 40 percent in either or both of the longitudinal and transverse directions and preferably in both the longitudinal and transverse directions.

The multilayer films of the present invention can exhibit a composite free shrink at a temperature of 200° F. (93° C.) of preferably at least 16 percent, more preferably at least 18 percent, more preferably at least 20 percent, more preferably at least 25 percent, and most preferably at least 30 percent. Preferred ranges for composite free shrink at a temperature of 200° F. (93° C.) are between 16 percent and 100 percent, more preferably between 20 percent and 90 percent, more preferably between 25 percent and 75 percent, and most preferably between 30 percent and 70 percent.

The multilayer films of the present invention can exhibit a free shrink balance at a temperature of 240° F. (115° C.) of preferably less than or equal to 30 percent, ore preferably less than 20 percent, more preferably less than 15 percent, more preferably less than 10 percent, and most preferably less than 5 percent. Preferred ranges for free shrink balance at a temperature of 240° F. (115° C.). are between 0 percent and 30 percent, more preferably between 0 percent and 20 percent, more preferably between 0 percent and 15 percent, more preferably between 0 percent and 10 percent, and most preferably between 0 percent and 5 percent.

The multilayer film of the present invention can be stretch oriented at stretching ratios of preferably at least 1.5:1, more preferably at least 2:1, more preferably at least 2.5:1, more preferably at least 3:1, more preferably at least 3.25:1, more preferably at least 3.5:1, more preferably at least 4:1, more preferably at least 4.5:1, and most preferably at least 5:1 in either or both of the longitudinal and transverse directions and preferably in both the longitudinal and transverse directions. Preferred ranges for stretch orientation ratios are preferably between 1.5:1 and 8:1, more preferably between 3:1 and 7:1, and most preferably between 4:1 and 6:1 in either or both of the longitudinal and transverse directions, and preferably in both the longitudinal and transverse directions.

The multilayer film of the present invention is preferably crosslinked, by chemical means or, more preferably, by irradiation such as by electron beam irradiation at a dosage of between 10 and 200, more preferably between 15 and 150, more preferably between 20 and 150, and most preferably between 20 and 100 kiloGray. Although the invention does not have to be irradiated, in a preferred embodiment, irradiation can be used to improve impact strength. Resin compositions suitable for use in the present inventive films have a melt index of preferably from 0.5 g/10 minutes to 30 g/10 minutes, more preferably from 1 g/10 minutes to 10 g/10 minutes, most preferably from 1.5 g/10 minutes to 2.5 g/10 minutes. Preferably, the film has a substantially balanced free shrink. Preferably, at least 50 percent by volume of the total film volume comprises a multicomponent ethylene/alpha-olefin resin having a melt index less than 5 g/10 minutes.

In preferred resin compositions, the homogeneous component forms between 30 percent and 60 percent by weight of the resin, and the heterogeneous component forms between 40 percent and 70 percent by weight of the resin. In more preferred resin compositions, the homogeneous component forms from 35 percent to 55 percent by weight of the resin, and the heterogeneous components forms from 45 percent to 65 percent by weight of the resin. In preferred resin compositions, the heterogeneous component has a melt index of 2.5 times greater than the melt index of the homogeneous component.

It is to be understood that variations of the present invention can be made without departing from the scope of the invention, which is not limited to the specific embodiments and examples disclosed herein.

TABLE 1
Coextruded Blown Film Fabrication Conditions

| Layer | Nylon 6,6/Primacor |
|---|---|
| components | 1410/Sealant |
| Layer Ratios | 0.75/0.5/0.5 |
| Blow up ratio | 2.5 |
| Die | 8 in Coex |
| Die Gap | 70 mil |
| Melt | Floats around |
| Temperature | 440-460° F. |
| Gauge | 1.75 mil |

Film properties are measured and reported in Table and with comparative examples. Dart impact (type B) of the films is measured in accordance with ASTM D-1709-85; tensile strength, yield, toughness, and 2 percent secant modulus of the films is measured in accordance with ASTM D-882; Elmendorf tear (type B) is measured in accordance with ASTM D-1922.

Puncture is measured by using an Instron tensiometer Tensile Tester with an integrator, a specimen holder that holds the film sample taut across a circular opening, and a rod-like puncturing device with a rounded tip (ball) which is attached to the cross-head of the Instron and impinges perpendicularly onto the film sample. The Instron is set to obtain a crosshead speed of 10 inches/minute and a chart speed (if used) of 10 inches/minute. Load range of 50 percent of the load cell capacity (100 lb. Load for these tests) should be used. The puncturing device is installed to the Instron such that the clamping unit is attached to the lower mount and the ball is attached to the upper mount on the crosshead. Six film specimens are used (each 6 inches square). The specimen is clamped in the film holder and the film holder is secured to the mounting bracket. The crosshead travel is set and continues until the specimen breaks. Puncture resistance is defined as the energy to puncture divided by the volume of the film under test. Puncture resistance (PR) is calculated as follows:
PR=E/((12)(T)(A))
where PR=puncture resistance (ft-lbs/in.sup.3)
E=energy (inch-lbs)=area under the load displacement curve
12=inches/foot
T=film thickness (inches), and
A=area of the film sample in the clamp=12.56 in.sup.2.

### EXAMPLE 1

Example 1 is an in-situ blend made according to U.S. Pat. No. 5,844,045, U.S. Pat. No. 5,869,575 and U.S. Pat. No. 6,448,341, wherein the homogeneously branched polymer is made in a first reactor and is an ethylene/1-octene copolymer having a melt index (I₂) of 1 g/10 min., and a density of 0.902 g/cm³, and a molecular weight distribution (Mw/Mn) of 2 and comprises 40 percent (by weight of the total composition). A heterogeneously branched ethylene/1-octene copolymer is made in a second reactor operated sequentially with the first reactor and has a melt index (I₂) of 2.5 g/10 min., and a density of 0.935 g/cm³ and comprises the remaining 60 percent (by weight of the total composition). The total composition has a melt index (I₂) of 1.8-2 g/10 min, a density of 0.9215 g/cm³, a melt flow ratio (I₁₀/I₂) of 7 and a molecular weight distribution (Mw/Mn) of 2.87. This composition is used as the sealant and made into oriented coextruded blown film as described in Table 1 and the resultant film properties are reported in Table 2.

In general, films made from the novel formulated ethylene/alpha-olefin compositions exhibit good impact and tensile properties, and an especially good combination of optics and tear. Further, films from the example resins exhibited significant improvements over films made from the comparative resins in a number of key properties.

TABLE 2

| | DOWLEX | |
|---|---|---|
| Resin | 2045G | Example 1 |
| Resin | | |
| Characteristics | | |
| I₂ | 1 | 1.8-2.0 |
| Density | 0.92 | 0.9215 |
| I₁₀/I₂ | — | 7 |
| Component A I₂ | — | 1 |
| Component A Density | — | 0.902 |
| Wt Fraction of component A | — | 40 |
| Component B I₂ | — | 2.5 |
| Component B Density | — | 0.935 |
| Heat Seal Strength | | |
| (lb/inch) @ Temperature | | |
| (° C.) | | |
| 90 | | |
| 100 | 0.068 | 0.104 |
| 110 | 2.275 | 2.878 |
| 120 | 5.464 | 5.45 |
| 130 | 6.3 | 6.424 |
| 140 | 6.53 | 6.4 |
| 150 | 6.186 | 6.738 |

DOWLEX 2045G is a heterogeneously branched ethylene/1-octene copolymer available from The Dow Chemical Company having a melt index (I₂) of 1 gram/10 minutes and a density of 0.92 grams/cubic centimeter.

1. A film comprising at least one layer made from a polymer composition, wherein the composition has at least two peaks, as determined using a CRYSTAF scan, from a temperature range from 35° C. to 100° C., wherein the CRYSTAF scan has an absence of a peak at a temperature range from 60° C. to 70° C.

2. A film comprising at least one layer made from a polymer composition, wherein the composition comprises
(A) from 10 percent (by weight of the total composition) to 95 percent (by weight of the total composition) of at least one homogeneously branched interpolymer having:
(i) a density from 0.86 grams/cubic centimeter (g/cm³) to 0.92 g/cm³,
(ii) a molecular weight distribution (Mw/Mn) from 1.8 to 2.8,
(iii) a melt index (I₂) from 0.2 grams/10 minutes (g/10 min) to 200 g/10 min,
(iv) no high density fraction; and
(B) from 5 percent (by weight of the total composition) to 90 percent (by weight of the total composition) of at least one heterogeneously branched polymer having a density from 0.88 g/cm³ to 0.945 g/cm³,
wherein the density of (A) is lower than the density of (B).

3. The film of claim 1 having a heat seal initiation temperature of no greater than 110° C.

4. The film of claim 1, wherein the composition has a melt index from 0.5 grams/10 minutes to 30 grams/10 minutes.

5. The film of claim 2 wherein the homogeneously branched polymer is an interpolymer of ethylene with at least one C₃-C₂₀ alpha-olefin.

6. The film of claim 2 wherein the heterogeneously branched polymer is a copolymer of ethylene and a C₃-C₂₀ alpha-olefin.

7. The film of claim 2 wherein the heterogeneously branched polymer is a copolymer of ethylene and 1-octene.

8. The film of claim 2 wherein the homogeneously branched interpolymer is a copolymer of ethylene and a C₃-C₂₀ alpha-olefin.

9. The film of claim 2 wherein the homogeneously branched ethylene/alpha-olefin copolymer is a copolymer of ethylene and 1-octene.

10. In a composition comprising at least one homogeneously branched ethylene/alpha-olefin interpolymer and at least one heterogeneously branched ethylene/alpha-olefin interpolymer, the improvement comprising the composition having at least two peaks, as determined using a CRYSTAF scan, from a temperature range from 35° C. to 100° C., wherein the CRYSTAF scan has an absence of a peak at a temperature range from 60° C. to 70° C.

11. A multilayer oriented heat shrinkable film comprising:
a) outer layers comprising an ethylene polymer composition having a melt index of less than 5 g/10 minutes, the composition comprising
i) a homogeneous component having a melt index of less than 3 g/10 minutes, and a density of at least 0.88 g/cc, and
ii) a heterogeneous component with a melt index of greater than or equal to 2 g/10 minutes up to 20 grams/10 minutes and a density greater than that of the homogeneous component, and
b) an internal layer comprising a polymeric resin;
wherein the film has a heat seal initiation temperature of 110° C. or less to achieve a heat seal strength of at least 2 pounds peak load.

12. The multilayer oriented heat shrinkable film of claim 11, wherein the polymeric resin of the internal layer comprises an ethylene polymer.

13. The multilayer oriented heat shrinkable film of claim 11, wherein the homogeneous component comprises from 30 to 50 percent by weight of the composition.

14. The multilayer oriented heat shrinkable film of claim 11, wherein the ethylene polymer composition has melt index of from 1.5 to 2.5 g/10 minutes.

15. A multilayer oriented heat shrinkable film comprising:
a) outer layers comprising an ethylene polymer composition having at least two peaks, as determined using a CRYSTAF scan, from a temperature range from 35° C. to 100° C., wherein the CRYSTAF scan has an absence of a peak at a temperature range from 60° C. to 70° C. and
b) an internal layer comprising a polymeric resin;
wherein the film has a heat seal initiation temperature of 110° C. or less to achieve a heat seal strength of at least 2 pounds peak load.
